(19) United States
(12) Patent Application Publication
(10) Pub. No.: US 2014/0227996 A1
(43) Pub. Date: Aug. 14, 2014

(54) METHOD FOR SELECTING A MOBILE TELEPHONY OPERATOR SO AS TO ALLOW A SUBSCRIBER, HAVING A MAIN SUBSCRIPTION, TO ENTER INTO A ROAMING SITUATION

(71) Applicant: GEMALTO SA, Meudon (FR)

(72) Inventors: Edmond Tuilier, Marseille (FR); Jean-François Kuc, La Destrousse (FR); Bertrand Leroux, Meudon (FR)

(73) Assignee: GEMALTO SA, Meudon (FR)

(21) Appl. No.: 14/348,355

(22) PCT Filed: Sep. 28, 2012
(86) PCT No.: PCT/EP2012/069177

§ 371 Date: Mar. 28, 2014

(30) Foreign Application Priority Data
Sep. 30, 2011 (EP) 11306270.7

(51) Int. Cl. H04M 15/00; H04W 48/18

(52) U.S. Cl. CPC H04M 15/50; H04W 48/18
USPC 455/406

(57) ABSTRACT

The invention relates to a method for selecting a mobile telephony operator so as to allow a subscriber, having a main subscription, to enter into a roaming situation, wherein said subscriber is using a mobile terminal. According to the invention, the method involves: i) suggesting the name of at least one alternative operator network, capable of providing roaming service, to the subscriber having a main subscription, said suggestion being accompanied by an indication of the roaming rate charged by said alternative operator network; and ii) after the user selects an alternative operator network, sending an IMSI to the mobile terminal, which enables said user to be connected to the alternative operator network so as to benefit from the roaming rate thereof.

### BACKGROUND

The field of the invention is that of telecommunications in cellular networks and more specifically relates to a method for selecting a mobile telephony operator so as to allow a subscriber, having a main subscription, to enter into a roaming situation with another operator.

A user of a mobile terminal (or a machine such as a motor vehicle connected by an operator network to a position tracking centre of the GPS type, an electronic tablet capable of being connected to a 3G cellular network or even a still camera or a camera that can send pictures to a website via a 3G network) takes a subscription with a national operator usually in his/her country of residence. For example, a French person currently can select a subscription with four national operators i.e. Orange, SFR, Bouygues and La Poste. This person may also take subscriptions with virtual operators (MVNO i.e. Mobile Virtual Network Operator) that use the national operators' infrastructures. After taking a subscription with one of these operators, the person can communicate, through his/her mobile terminal, on said operator's network.

Document CA-2.451.313 describes a method enabling a user in a roaming situation to be connected to another operator's WiFi network. This method does not, however, apply to the field of telecommunications in the broad sense of the term, as it is limited to WiFi roaming.

Operators, whether major ones or operators of the MVNO type (in the following, these operators will be referred to as those managing a so-called main subscription), usually sign roaming agreements with foreign operators (usually at the world level) so that the user can communicate outside his/her country of origin. For example, Orange has signed roaming agreements with operators in Italy for the French subscribers to be able to benefit from the same communication services in Italy and in France. The only difference for the user is that the price of his/her communications will be higher when he/she is in Italy than if he/she were in France.

For example, Orange notably has signed roaming agreements with TIM, Wind and H3G which are three Italian operators. The French user who travels to Italy knows, in principle, the price of roaming communications which is communicated to him/her by Orange. The same is true for other foreign countries, whatever the visited network he/she uses. This means that the user will pay to Orange the same amount by communication unit (e.g. per minute) whether he/she connects to Tim, Wind or H3G, e.g. 50 Euro cents per minute of communication. Rate agreements have been signed between Orange and the three Italian operators but they are not necessarily all equal. For example, TIM will charge Orange 22 Euro cents, Wind 25 cents and H3G 30 cents per minute of communication. As the operator Orange charges the user 50 cents per minute, its margin is higher if the user is connected to the TIM network, a little less if he/she is connected to the Wind network and the lowest if the user is connected to the H3G network. The main subscription operator (Orange) has great interest in the subscriber being connected to the TIM network when in a roaming situation. The latter network will then be displayed as the favourite roaming network in a so-called PLMN file residing in the subscriber's SIM card. The PLMN file can be updated via OTA by the main operator (i.e. Orange).

The main drawback of this existing solution is that, when in a roaming situation, the user always pays the same price to his/her main operator and he/she is linked to such main operator by contract. Now, another operator, called the alternative operator in the following, may have signed better roaming agreements with operators in Italy and thus this operator may charge a cheaper rate per minute for a communication in a roaming situation. Now, as the user has not taken any subscription with this alternative operator (e.g. SFR, Bouygues or La Poste, or a foreign (German, Belgian, Spanish operator)), he/she cannot benefit from such more favourable roaming rates.

The European Commission has recently issued a proposition aiming at reducing the roaming rates (refer to: http://www.euractiv.com/en/infosociety/eu-wants-mobile-roaming-surchargs-2014-news-506229).

The present invention more particularly aims at providing a solution to these roaming extra costs and more precisely one of the objectives of the invention is to enable a client of a major operator to benefit from better roaming rates than those charged by his/her main operator, without him/her having to change his/her main operator (take a subscription with SFF and cancel his/her subscription with Orange in the example above).

### SUMMARY

This object, and others which will become apparent hereinafter, are achieved by a method for selecting a mobile telephony operator so as to allow a subscriber, having a main subscription, to enter into a roaming situation, with said subscriber using a mobile terminal, characterized in that it involves:
i—suggesting the name of at least one alternative operator network, capable of providing a roaming service, to said subscriber having a main subscription, said suggestion being accompanied by an indication of the roaming rate charged by said alternative operator network;
ii—after said user selects an alternative operator network, sending an IMSI to said mobile terminal, which enables said user to be connected to the alternative operator network so as to benefit from the roaming rate thereof.

The step -i- is preferably preceded by a step of detecting that said mobile terminal is in a roaming situation. In an advantageous implementation of the invention the IMSI is accompanied by a key Ki.

The IMSI preferably enabling the user to be connected to the alternative operator network is replaced by the IMSI of the operator managing the main subscription when the latter is no longer in a roaming situation.

Advantageously, the IMSI enabling the user to be connected to said alternative operator network is transmitted by the service provider of the main subscription.

Other characteristics and advantages of the invention will become apparent upon reading the following description of one embodiment of the invention, given by way of illustration and not as a restriction, and the accompanying single Figure showing the operation of the present invention.

### BRIEF DESCRIPTION OF THE DRAWINGS

FIG. 1 is a block diagram that schematically illustrates the options available to a user in accordance with one embodiment of the invention

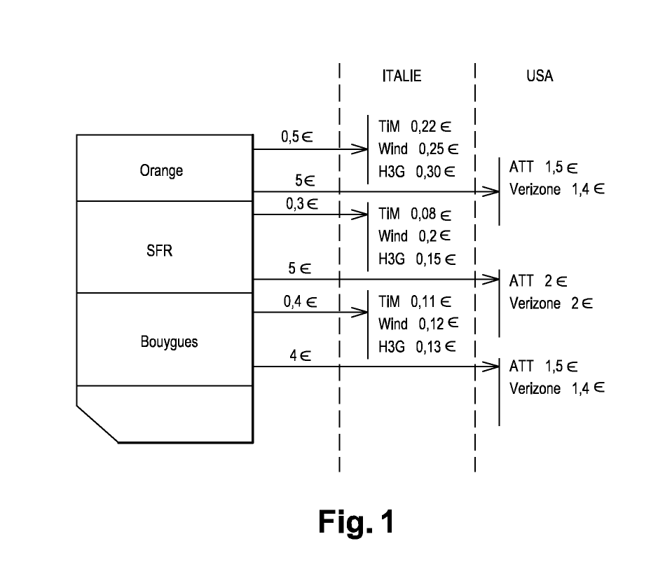

### DETAILED DESCRIPTION

The situation examined here is that of a subscriber having a main subscription with Orange. So he/she uses the Orange network for his/her mobile communications when in France.

Let it be assumed that the subscriber wishes to go to Italy for a business trip or a vacation. He/she knows that, by contract, Orange will charge him/her 0.5 Euros per minute of communication (voice, data, . . . ), whatever the Italian network used (here TIM, Wind or H3G).

The invention consists of an applet (software application) installed in the user's terminal, preferably in his/her Orange SIM or UICC card (or in a eUICC if this is a SIM or UICC functionality permanently welded in a mobile machine) enabling the user to select an alternative operator network, other than Orange, which can provide a more financially attractive roaming service when he/she goes to Italy.

To do this, two embodiments are possible:

In a first embodiment of the invention, the user accesses a functionality of his/her mobile terminal, allowing him/her to know the roaming rate that will be applied to him/her if he/she goes to Italy. The main operator then sends him/her the name of at least one alternative operator capable of providing this roaming service in Italy. For example, with reference to the single Figure, the user can select Orange, SFR or Bouygues as his/her main operator. Each operator is associated with a roaming rate. For example, Orange will charge 0.5 Euros per minute of communication, SFR will charge 0.3 Euros and Bouygues 0.4 Euros. These rates do not depend on the network which the user's terminal will be connected to in Italy. Orange will charge the user 0.5 Euros and pay 0.22 Euros to TIM if this network is used, 0.25 Euros to Wind and 0.3 Euros to H3G as from the moment the user selects Orange as his/her main network.

SFR's roaming rate is the lowest: 0.3 Euros per minute of communication, since SFR has negotiated lower rates with Tim (0.08 Euros), Wind (0.2 Euros) and H3G (0.15 Euros). Bouygues offers an intermediate roaming rate (0.4 Euros), since it has negotiated rates amounting to 0.11 Euros, 0.12 Euros and 0.13 Euros with TIM, Wind and H3G respectively.

The user's interest is thus to select SFR as the alternative operator, for costs reasons.

This selection can be performed manually using the man-machine interface of the terminal.

If the user decides to go to the United States, Orange and SFR will offer him/her a roaming rate amounting to five Euros per minute, while Bouygues will offer a lower rate (four Euros). The user wishing to go to the United States will thus have to select Bouygues as the alternative operator.

The list of the alternative operators can be downloaded, via OTA, into the terminal SIM card, UICC or eUICC, or automatically upon each rate updating, or at the user's request.

In a second embodiment of the invention, when in a roaming situation is detected by the terminal, i.e. when the user crosses the border between France and Italy, or arrives in the United States, the application will automatically offer him/her the choice between the alternative operators available.

In both embodiments, the user selects the alternative operator offering him/her the best roaming rates. His/her main operator (Orange) then transmits to the user's terminal an identifier (with the adequate safety measures) enabling him/her to be connected to the selected alternative operator network, so that the user can get the most appropriate roaming rate. This identifier is typically an IMSI enabling the terminal to authenticate with the alternative operator network via the visited network (TIM, Wind, H3G in Italy and ATT or Verizone in the United States).

For the authentication to be complete, the key Ki must, of course, be shared by the main operator and the alternative operators. If such sharing of the key Ki does not exist between the operators, the identifier transmitted to the terminal comprises not only the IMSI, but also a key Ki.

Advantageously, the identifier used to connect to the alternative operator network is replaced by the IMSI and the key Ki of the operator managing the main subscription when the user is no longer in a roaming situation, i.e., in the previous example, when he/she goes back to France.

The alternative operator(s) suggested to the user do(es) not necessarily have the same nationality as the main operator. Thus, Orange could offer Telefonica (Spain) as an alternative operator if the latter enters into an agreement with Orange (and especially if Telefonica offers more interesting roaming rates in Italy (or in other countries) than the national alternative operators).

The roaming rate applied by the alternative operator network may be presented to the user in different forms: either an indication of the actual rate that will be applied by the alternative operator, or a ranking of the alternative operators (possibly including the main operator in both cases), depending on the roaming rate (the cheapest operator being displayed first in the list proposed to the user).

1. A method for selecting a mobile telephony operator so as to allow a subscriber, having a main subscription, to enter into a roaming situation, with said subscriber using a mobile terminal, comprising:
i—suggesting the name of at least one alternative operator network, capable of providing a roaming service, to said subscriber having a main subscription, said suggestion being accompanied by an indication of the roaming rate charged by said alternative operator network;
ii—after said user selects an alternative operator network, sending an IMSI to said mobile terminal, which enables said user to be connected to the alternative operator network so as to benefit from the roaming rate thereof.

2. A method according to claim 1, wherein step -i- is preceded by a step of detecting that said mobile terminal is in a roaming situation.

3. A method according to claim 1, wherein said IMSI is accompanied by a key Ki.

4. A method according to claim 1, wherein said IMSI enabling the user to be connected to said alternative operator network is replaced by the IMSI of the operator managing said main subscription when the user is no longer in a roaming situation.

5. A method according to claim 1, wherein said IMSI enabling the user to be connected to said alternative operator network is transmitted by the service provider of said main subscription.
